(19) United States
(12) Patent Application Publication
(10) Pub. No.: US 2019/0084436 A1
(43) Pub. Date: Mar. 21, 2019

(54) ELECTRIC VEHICLE CHARGER RETURN SYSTEM

(71) Applicant: Ford Global Technologies, LLC, Dearborn, MI (US)

(72) Inventor: Erik J. CHRISTEN, Royal Oak, MI (US)

(21) Appl. No.: 15/710,054

(22) Filed: Sep. 20, 2017

(51) Int. Cl. B60L 11/18; G06Q 20/38; G07F 15/00

(52) U.S. Cl. CPC B60L 11/1848; G07F 15/005; G06Q 20/3821; B60L 11/1816

(57) ABSTRACT

An electric vehicle charging station including a cord terminating at a plug is provided. The charging station may include a controller that may be configured to, responsive to receiving payment credentials from a user and identification of a charge-stopping event, provide electricity to the cord to induce an electromagnetic field, and responsive to a current associated with the electromagnetic field exceeding a predetermined threshold, permit processing of the payment credentials to complete payment.

### TECHNICAL FIELD

The present disclosure relates to charging systems for electric and hybrid vehicles.

### BACKGROUND

Generally, electric vehicles differ from conventional motor vehicles because electric vehicles are selectively driven using one or more battery-powered electric machines. Conventional motor vehicles, by contrast, rely exclusively on an internal combustion engine to drive the vehicle. Electric vehicles may use electric machines instead of, or in addition to, the internal combustion engine.

Example electric vehicles include hybrid electric vehicles (HEVs), plug-in hybrid electric vehicles (PHEVs), and battery electric vehicles (BEVs). Electric vehicles are typically equipped with a battery containing multiple battery cells that store electrical energy for powering the electric machine. The battery may be charged prior to use or once the battery has been depleted. Chargers, whether they are for public use or private use, may be utilized to charge the vehicle battery. The chargers may include a cord that is disposed between the charger and the connector. If the cord is not properly returned, it may be exposed to standing water or snow or driven over by a nearby vehicle.

### SUMMARY

According to one embodiment of this disclosure, an electric vehicle charging station including a cord terminating at a plug is provided. The charging station may include a controller that may be configured to, responsive to receiving payment credentials from a user and identification of a charge-stopping event, provide electricity to the cord to induce an electromagnetic field, and responsive to a current associated with the electromagnetic field exceeding a predetermined threshold, permit processing of the payment credentials to complete payment.

According to another embodiment of this disclosure, an electric vehicle charging station including a cord terminating at a plug is provided. The charging station may include a controller that may be configured to, responsive to receiving payment credentials from a user, identification of a charge-stopping event, and an electromagnetically induced current on the cord exceeding a predetermined threshold, permit processing of the payment credentials to complete payment, otherwise retain the payment credentials.

According to yet another embodiment of this disclosure, an electric vehicle charging station including a cord terminating at a plug is provided. The charging station may include a controller that may be configured to, responsive to receiving payment credentials from a user, identification of a charge-stopping event, and a load on a cord holder exceeding a predetermined threshold, permit processing of the payment credentials to complete payment, otherwise retain the payment credentials.

### BRIEF DESCRIPTION OF THE DRAWINGS

FIG. 1 is a perspective view of a prior-art charger for an electrical vehicle.

FIG. 2 is a perspective view of an exemplary charger for an electric vehicle.

FIG. 3 is schematic diagram of an exemplary circuit for a charger return system.

FIG. 4 is schematic diagram of an exemplary circuit for a charger return system according to another embodiment.

FIG. 5 is a flow chart illustrating a method of operating the charger return system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

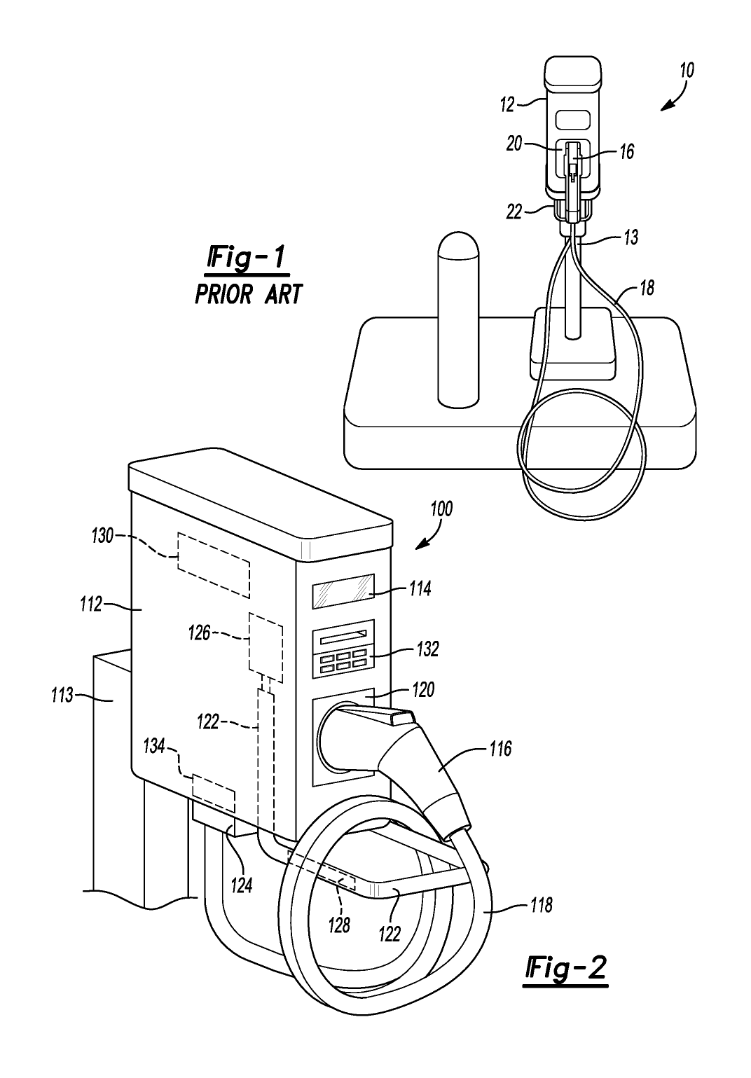

Referring to FIG. 1, a perspective view of an exemplary prior-art electric vehicle charger is illustrated. The prior-art charger 10 includes a charger housing 12 attached to a post or pole 13. The charger 10 includes a connector 16 that is connected to the housing 12 by a cord 18. The connector 16 is held or plugged into the connector aperture 20 within the charger housing 12. A hook or arm 22 is connected to a bottom portion of the housing. Note the cord 18 of the prior-art charger 10 is not coiled around the hook or arm 22. Rather, the cord 18 is strewn about the ground beneath the prior art charger 10. The cord 18 may be susceptible to liquid, such as water, oil, vehicle fluid, etc. when it is left on the ground. Moreover, the risk of an approaching vehicle driving over the cord increases when the cord 18 is not properly replaced on the hook or arm 22 of the charger 10.

Referring to FIG. 2, a perspective view of an exemplary electric vehicle charger 100 according to one or more embodiments is illustrated. The electric vehicle charger 100 includes a charger housing 112 attached to a post or a pole 113. The charger 100 may include a connector 116 that is connected to the housing 112 by a cord 118. The end of the cord 118 opposite the connector 116 may be attached to the charging housing 112 by a plug 124. The connector 116 is held or plugged into a connector aperture 120 within the charging housing 112. A hook or arm 122 may be connected or extend from the charging housing 112. The hook or arm 122 is U-shaped, though it may have another shape such as a single arm or another suitable configuration to hold a looped or coiled cord 118.

The charging station 112 may include a human-machine interface “HMI” 114 that is disposed within an exterior wall of the charging station 112. The HMI 114 may be a light-emitting diode “LED” or other suitable screen that may indicate the status of the charging station, e.g., not charging, charging, and charging connector properly returned. A payment or account module 132 may be disposed within the housing 112. A user may enter his or her account information or payment credentials, e.g., credit card, debit card, account information associated with the charger, etc. to allow use of the charger. The HMI 114 and payment or account module 132 may be electrically connected to a controller 130 disposed within the housing 112.

The controller 130 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the charger.

Control logic or functions performed by the controller 130 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based charger, such as controller 130. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

A load sensor or weight sensor 126 may be electrically or mechanically connected to the controller 130. The load sensor 126 is connected to the hook or arm 122. The load sensor 126 may measure the load or weight applied to the hook or arm 122. Note that while the hook or arm 122 is disposed below the load or weight sensor 126, the load or weight sensor may be positioned in another suitable position. In addition to or in lieu of the weight sensor 126, an electromagnetic sensor or current sensor 128 may be utilized to measure or detect the presence of current or an electromagnetic field generated by a current supplied through the cord 118. An electrical current may be supplied by a current source 134 through the cord 118 to determine whether the cord has been returned to the hook 122.

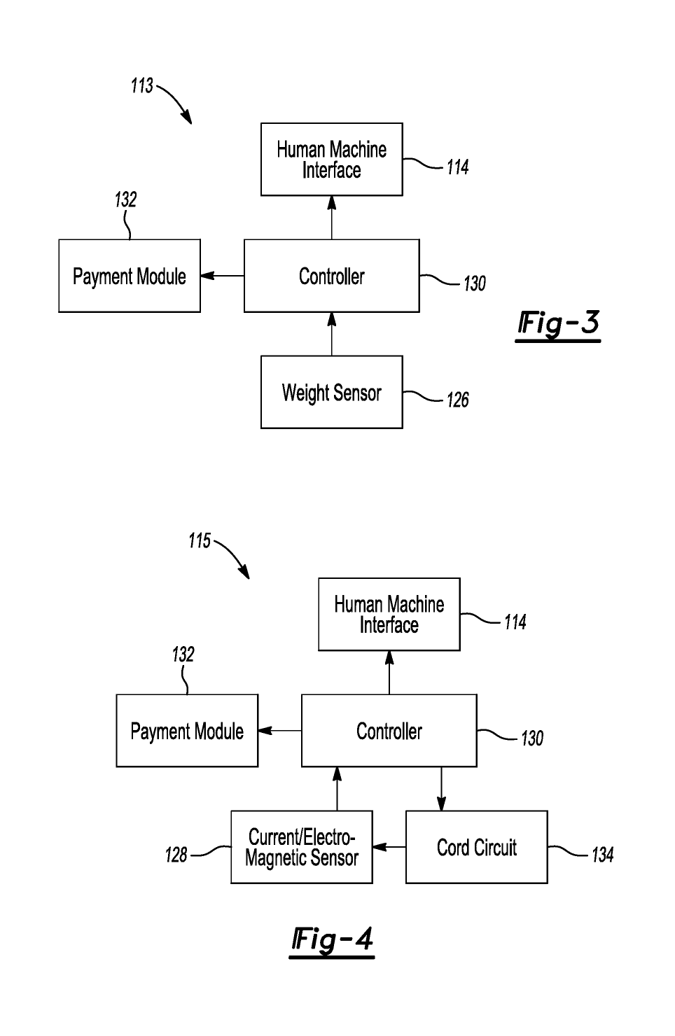

Referring to FIG. 3 and FIG. 4, a schematic diagram of an exemplary circuit for the charger return system is illustrated. Referring specifically to FIG. 3, the circuit 113 includes the controller 130 that may receive a measured weight or load from the weight sensor 126. As mentioned, the weight sensor 126 may be a strain gauge, or other suitable load measurement device. A strain gauge often consists of an insulating flexible backing that supports a metallic foil portion. As a load is applied to the strain gauge the electrical resistance of the metallic foil may be altered according to the load applied to the hook or arm 122. The controller 130 may include a program or logic that compares the measured load with a known reference value. In response to the measured load, the controller 130 may send a signal to the payment module 132 and the HMI 114. Referring specifically to FIG. 4, another circuit 115 including the electromagnetic sensor 128 is illustrated. While the circuit 115 is similar to the circuit 113, this circuit employs the current source 134 applied through the cord 118 and the electromagnetic sensor 128. The controller 130 may provide a signal to the current source 134 to apply a current through the cord 118. The electromagnetic sensor 128 sends a signal of the measured current or electromagnetic field to the controller 130. As outlined above, the controller may send a signal to the HMI 114 and the payment module 132.

In combination with the load or weight sensor 126 or without the load sensor 126, an electromagnetic or current sensor 128 may be employed. The electromagnetic or current sensor 128 may be disposed within the hook or arm 122. A current source 134 may be disposed within the housing 112 and provide a relatively low voltage current through the cord. When the current is supplied from the current source 134 through the cord 118, the electromagnetic sensor 128 disposed within the hook or arm 122 is configured to measure the current supplied through the cord 118. The more the cord is coiled or looped around the hook or arm 122, the greater the electromagnetic field is present. Meaning if the only one loop or coil of the cord 118 is wrapped around the hook or arm 122 the electromagnetic field or current detected by the electromagnetic sensor 128 is less than the measured electromagnetic field or current measured if more than one loop or coil of the cord is wrapped around the hook or arm 122.

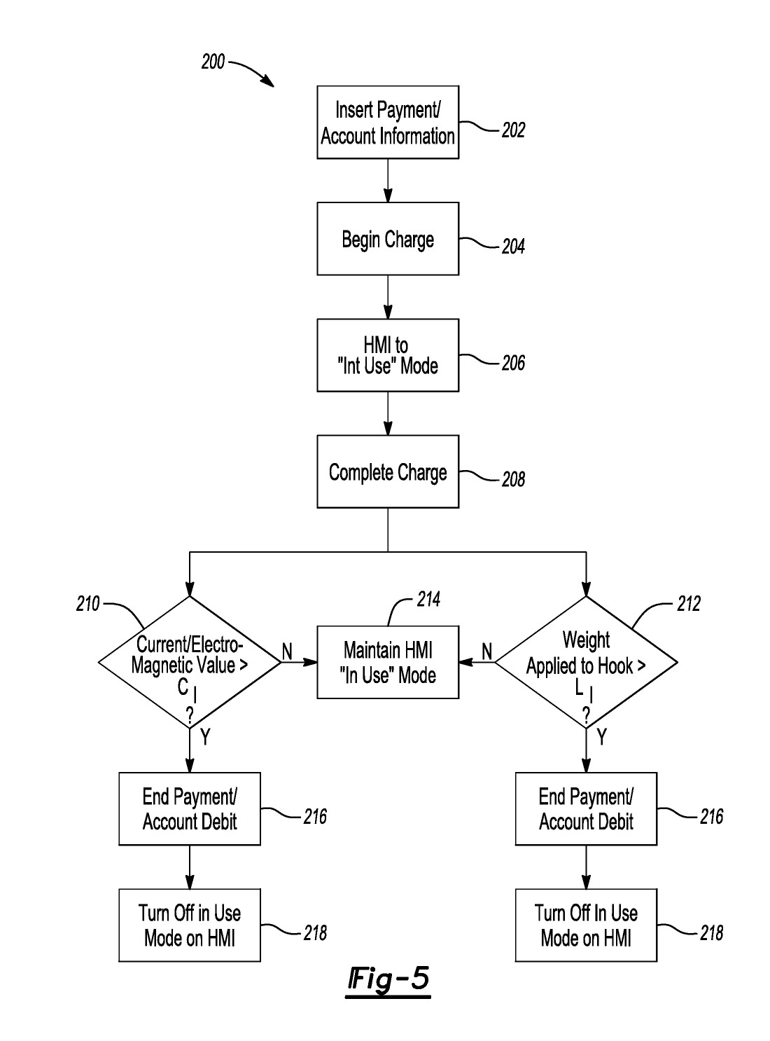

Referring to FIG. 5, a flowchart illustrating a method 200 of operating the charger return system is illustrated. It should be understood that the flowchart in FIG. 5 is for illustrative purposes only and that the method 200 should not be construed as limited to the flowchart in FIG. 5. Some of the steps of the method 200 may be rearranged while others may be omitted entirely.

In operation 202, a user may insert her payment or account information to allow the user to remove the connector 116 from the connector aperture 120, place it in the vehicle charger port and begin charging. In operation 204, the user may begin charging the vehicle. In operation 206, at or shortly after the charging has begun, the HMI moves to “in use mode.” In this mode, a light or screen may provide certain indicia to make the user aware that the vehicle is charging, the rate of charge, percentage of charge, and remaining time to complete the charge.

In operation 208, the controller determines that the vehicle has completed the charging process. After operation 208, the method may branch along method A, method B, or both. Moving along method A, in operation 210 the controller 130 branches based on a measured current or electromagnetic value being greater than a predetermined threshold C₁. In operation 210, the controller 130 receives a measured current or measured electromagnetic value from the current sensor 128. The controller than determines whether that measured value is greater than the predetermined threshold C₁. If the measured value is not greater than C₁, the controller branches to operation 214. If the measured value is greater than C₁, the controller branches to operation 216. In operation 214, the HMI stays in the in-use mode and alerts the user that the process has not been completed. The controller may maintain the user's payment or account information and debit the user for failing to replace or return the cord 118 to its proper place. In operation 216, the controller ends the payment process, to allow the user to collect her card or receipt for the transaction. In operation 218, the HMI changes its status to indicate that it is ready to begin charging the next vehicle.

Moving along method B, the controller in operation 212 branches based on a load or weight on the hook 122 measured by the load sensor 126 exceeds a predetermined threshold L₁. If the load is not greater than the predetermined threshold L₁, the controller branches to operation 214. In operation 214, the HMI stays in the in-use mode and alerts the user that the process has not been completed. The controller may maintain the user's payment or account information and debit the user for failing to replace or return the cord 118 to its proper place. If the load is greater than the predetermined threshold L₁, the controller branches to operation 216. In operation 216, the controller ends the payment process, to allow the user to collect her card or receipt for the transaction. In operation 218, the HMI changes its status to indicate that it is ready to begin charging the next vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electric vehicle charging station including a cord terminating at a plug, comprising:
a controller configured to, responsive to receiving payment credentials from a user and identification of a charge-stopping event, provide electricity to the cord to induce an electromagnetic field, and responsive to a current associated with the electromagnetic field exceeding a predetermined threshold, permit processing of the payment credentials to complete payment.

2. The charging station of claim 1, wherein the controller is further configured to send a signal to a human-machine-interface device to display indicia indicating the cord has been returned to a holder.

3. The charging station of claim 1, wherein the controller is further configured to, responsive to the current not exceeding the predetermined threshold, prohibit processing of the payment credentials.

4. The charging station of claim 3, wherein the controller is further configured to send a signal to a human-machine-interface device to display indicia indicating the cord has not been returned to a holder.

5. The charging station of claim 1, wherein the controller is further configured to receive a signal indicative of a measured weight by a load sensor connected to a holder.

6. The charging station of claim 5, wherein the controller is further configured to, responsive to the measured weight not exceeding a second predetermined threshold, prohibit processing of the payment credentials.

7. The charging station of claim 6, wherein the controller is further configured to, responsive to the current not exceeding the predetermined threshold and the measured weight not exceeding the second predetermined threshold, prohibit processing of the payment credentials.

8. A charging station including a cord terminating at a plug, comprising:
a controller configured to, responsive to receiving payment credentials from a user, identification of a charge-stopping event, and an electromagnetically induced current on the cord exceeding a predetermined threshold, permit processing of the payment credentials to complete payment, otherwise retain the payment credentials.

9. The charging station of claim 8, wherein the controller is further configured to, responsive to the electromagnetically induced current on the cord exceeding the predetermined threshold, send a signal to a human-machine-interface device to display indicia indicating the cord has been returned to a holder.

10. The charging station of claim 8, wherein the controller is further configured to, responsive to the electromagnetically induced current on the cord not exceeding the predetermined threshold, send a signal to a human-machine-interface device to display indicia indicating the cord has not been returned to a holder.

11. The charging station of claim 8, wherein the controller is further configured to receive a signal indicative of a measured weight by a load sensor connected to a holder and compare the measured weight to a second predetermined threshold.

12. The charging station of claim 11, wherein the controller is further configured to, responsive to the electromagnetically induced current on the cord exceeding the predetermined threshold and the measured weight exceeding the second predetermined threshold, compare the predetermined threshold and the second predetermined threshold to a third predetermined threshold.

13. An electric vehicle charging station including a cord terminating at a plug, comprising:
a controller configured to, responsive to receiving payment credentials from a user, identification of a charge-stopping event, and a load on a cord holder exceeding a predetermined threshold, permit processing of the payment credentials to complete payment, otherwise retain the payment credentials.

14. The charging station of claim 13, wherein the controller is further configured to, responsive to an electromagnetically induced current on the cord exceeding a second predetermined threshold, permit processing of the payment credentials to complete payment, otherwise retain the payment credentials.

15. The charging station of claim 13, wherein the controller is further configured to send a signal to a human-machine-interface device to display indicia indicating the cord has been returned to a holder.

16. The charging station of claim 13, wherein the controller is further configured to send a signal to a human-machine-interface device to display indicia indicating the cord has not been returned to a holder, in response to the load on the cord holder not exceeding the predetermined threshold.
